(19) United States
(12) Patent Application Publication
(10) Pub. No.: US 2017/0264501 A1
(43) Pub. Date: Sep. 14, 2017

(54) SYSTEM AND METHOD FOR GENERATING ADVICE FOR IMPROVING INTERNET AND WIFI PERFORMANCE IN A NETWORK USING MACHINE-LEARNING TECHNIQUES

(71) Applicant: Catalina Labs, Inc., Palo Alto, CA (US)

(72) Inventors: Mayandran Mathen, Palo Alto, CA (US); Shailendra Karody, Palo Alto, CA (US); Shahar Zimmerman, Palo Alto, CA (US)

(21) Appl. No.: 15/457,342

(22) Filed: Mar. 13, 2017

Related U.S. Application Data
(60) Provisional application No. 62/308,168, filed on Mar. 14, 2016.

(51) Int. Cl. H04L 12/24

(52) U.S. Cl. CPC H04L 41/16; H04L 41/14; H04W 84/12

(57) ABSTRACT

A system and method collects data about a device on a premises and uses a machine-learning advice engine to automatically identify specific conditions affecting home internet and WiFi performance, determine possible root causes underlying such conditions, provide an actionable advice or one or more pieces of advice to address, modify, resolve, or repair the conditions, and implement automated fixes where applicable in order to optimize and improve the internet and WiFi performance in a home network.

### PRIORITY CLAIMS

This application claims the benefit under 35 USC 119(e) and priority under 35 USC 120 to U.S. Provisional Patent Application Ser. No. 62/308,168 filed Mar. 14, 2016 and entitled “Improving Internet And Wi-Fi Performance In A Home Network Using Machine-Learning Techniques”, the entirety of which is incorporated herein by reference.

### FIELD

Exemplary embodiments relate generally to the field of internet and WiFi performance, and more specifically, to a system and method for automated identification of specific conditions affecting internet and WiFi performance, diagnosis of possible root causes underlying the conditions, provision of an actionable one or more pieces of advice to address, modify, resolve, or repair the conditions, and automated fixes where applicable in order to optimize and improve a user's quality of experience.

### BACKGROUND

Home Internet is a well-characterized field and a dominant part of a consumer's lifestyle. Home Internet usage is deemed to be similar to any other utility such as water, gas, or electricity that is consumed by the public with an expectation that the necessary infrastructure will be maintained and provided as a basic service.

Due to the rapid proliferation of Internet-enabled and WiFi devices that connect discrete services such as appliances, health devices, fitness devices, and entertainment services, coupled with the post-PC new form factor devices that are essentially “always-on,” the home internet and WiFi service is typically unable to satisfy the quality expectation of a typical consumer.

Entertainment services are also seeing a rapid convergence wave where the Internet is used as a delivery channel instead of traditional broadcast media such as cable or satellite infrastructure. This shift in the delivery model for entertainment and other services drives the requirement for a higher quality Internet medium—typically something that consumers have not been concerned about.

Although there are a number of factors that influence a high quality internet experience and that are well understood in the non-consumer infrastructure and application services realm, these factors and understanding have yet to be extrapolated to the home internet domain. The IEEE 802.11 standard governs the operation of the wireless technology that seamlessly connects devices and networks to routers and gateways. The IEEE 802.3 standard governs the operation of the connection between modems and routers or gateways while the DOCSIS and ITU-T G.992.1 standards guide the broadband technologies that connect the home to the cable or analog telephony internet services provided by telecommunications providers. These individual domains operate independently from each other and are brought together through either a single gateway router box or through a few boxes that the consumer and telecommunications providers provide as part of their service.

Problems that occur in each individual domain contribute to the quality and performance of the end service that is consumed. For example, jitter or packet loss due to broadband network congestion may cause multimedia voice and video conversations to be of poor quality. The home user typically does not have the ability to identify, diagnose, or resolve problematic conditions and their underlying causes and is often limited to a Wi-Fi signal quality indicator as the only measure of overall network quality. In addition, while certain diagnostic tools or services may exist for a particular device or service provider, for example, variations of a third-party background diagnostic service for internet service providers (ISP's) and consumer applications (Netflix, YouTube, etc.), none of these is able to provide a comprehensive view of the home internet performance that includes not only the particular devices and their configuration in the home network, but also the empirical, environmental (i.e. related to the home network environment), and other data specific to and uniquely identified with a particular home network.

While human specialists may be called upon to identify, diagnose, or resolve problematic conditions affecting home internet performance, their abilities are limited with respect to accessing, processing, analyzing, aggregating, and extracting critical information or inferences from the type and amount of data available in the home network in order to optimize home internet and WiFi performance. More importantly, unlike an automated expert system, a human service is unable to respond on demand in a near instantaneous fashion (i.e. within a few minutes or a few seconds) when problems do arise. A human service cannot provide a user with the ability to monitor the home internet performance in real time, nor would the human service be able to recognize and learn automatically from complex patterns that arise in the large amounts of available data. Finally, a human service cannot adjust or adapt nearly instantaneously to the dynamic conditions or changing network parameters that exist in today's home network environments.

Given that the home network is not static but is constantly changing and evolving due to conditions in the home network environment and due to the interaction of various devices, many of which may be added, removed, or modified within the home network, what is needed to address this specific technical problem is an expert system and comprehensive end-to-end methodology without the limitations described above. This system and methodology would replace the need for human diagnosis on site, which is currently the only means an average consumer has to resolve problematic conditions affecting home internet and WiFi performance. The system should be able to take as input various types of data available from the home network, including empirical data (e.g. network statistics and performance indicators). The system should also have the ability to recognize complex patterns in the available data in order to automatically diagnose any possible root causes of problematic conditions affecting home internet and WiFi performance. Additionally, the system should be able to provide actionable one or more pieces of advice to address, modify, resolve, or repair a problematic condition. Finally, such a system should have the ability to adjust to changing conditions and network parameters, and should continue to evolve and improve its diagnoses and pieces of advice over time as additional data particular to a home network is generated or becomes available. This level of empowerment does not currently exist for end users of Internet or WiFi-enabled services.

### BRIEF DESCRIPTION OF THE DRAWINGS

The novel features of the disclosure are set forth with particularity in the appended claims. A better understanding of the features and advantages of the disclosure will be obtained by reference to the following detailed description that sets forth illustrative embodiments, in which the principles of the disclosure are utilized, and the accompanying drawings of which:

FIGS. 1A-1B are flowcharts showing a number of steps in an exemplary method;

FIGS. 2A-2C are block diagrams showing a number of components of an exemplary first embodiment of the system;

FIGS. 3A-3G depict examples of a graphical interface for use in the exemplary first embodiment;

FIG. 4 illustrates another embodiment of the system that may be used to provide data to third party partners;

FIG. 5 illustrates more details of the ingester component shown in FIG. 4.

FIG. 6 illustrates an example of a graphical interface generated in an exemplary embodiment;

FIG. 7 shows further details of the user interface in FIG. 6;

FIG. 8 illustrates an example of an issues user interface that may be generated by the system;

FIG. 9 illustrates a status user interface for a user of the system;

FIGS. 10A-10C illustrate further details of the user interface shown in FIG. 9;

FIG. 11 illustrates a user interface for a particular device that is part of the network that shows further details about that device; and

FIG. 12 illustrates an example of an internet service provider user interface that may be generated by the system.

### DETAILED DESCRIPTION OF ONE OR MORE EMBODIMENTS

The disclosure is particularly applicable to a system that collects data from a wireless router device and provides advice, using a machine learning advice engine, to a consumer or an internet service provider about the wireless router device and it is in this context that the disclosure will be described. It will be appreciated, however, that the system and method has greater utility because: 1) the system and method may be used to collect data from various IoT devices and may generate machine learning based advise about the various IoT devices; 2) the system and method is described below in the illustrative example as using a particular machine learning algorithm, but the system and method may be implemented using various known or yet to be developed machine learning algorithms; and 3) the system and method may be implemented using other computer architectures, elements that those shown in the examples below and those modifications to the implementation of the system and method are within the scope of the disclosure.

A method and system are provided for improving internet and WiFi performance in a home network using a machine-learning advice engine to provide actionable pieces of advice to address problematic conditions that affect performance in the home network. The automated machine-learning advice engine interfaces with one or more sensor devices, human interface devices, or home internet appliances in a home network to make inferences based on various data affecting internet and WiFi performance. The various data are generated, collected, stored, processed, and analyzed by the internet performance system in order to provide actionable pieces of advice for modifying problematic conditions that affect internet and WiFi performance in a home network.

For clarity of presentation, the method and system in the present disclosure are exemplified and described as applicable to a home network, although the system and method's use is not limited to the home (i.e. a user's residence) and may be applied to other networks that connect or service Internet-enabled and WiFi-enabled devices or appliances, for example in an office, business, or other non-residence, wherein a user seeks to optimize and improve the internet or WiFi performance associated with the use of those devices or appliances.

In a first aspect, a method for improving internet and WiFi performance in a home network using a machine-learning advice engine comprises collecting network environmental data (i.e. data related to the home network environment) from one or more sensor devices, human interface devices, or home internet appliances in the home network and conducting performance tests to generate testing data from one or more testing servers, wherein the testing data reflects various characteristics related to home internet or WiFi performance. An automated advice engine interfaces with the one or more sensor devices, human interface devices, or home internet appliances in the home network. The automated advice engine independently performs a number of steps in order to provide one or more actionable pieces of advice for improving internet and WiFi performance. In particular, the automated advice engine formats the collected network environmental data and the generated testing data to a standardized format, stores the formatted network environmental data and the formatted testing data, and processes the formatted network environmental data, the formatted testing data, and previously stored historical data using machine learning techniques. In addition, processing by the automated advice engine further comprises: identifying one or more conditions affecting internet or WiFi performance in the home network based on at least one of the processed network environmental, testing, and historical data; diagnosing one or more causes underlying the one or more conditions affecting internet or WiFi performance in the home network; and analyzing and applying machine learning techniques to the one or more conditions to provide one or more actionable pieces of advice to modify the one or more conditions. The method further comprises taking one or more actions corresponding to the one or more actionable pieces of advice to modify the one or more identified conditions to improve home internet and WiFi performance.

These and other embodiments are described in further detail in the following description related to the appended drawing figures.

Specific embodiments of the disclosed method and system will now be described with reference to the drawings. Nothing in this detailed description is intended to imply that any particular step, component, or feature is essential.

The system and method aims to inform consumers of a comprehensive statistically calculated method to improve their home internet and WiFi performance, quality of experience, and security. No such method currently exists for consumers let alone one that is comprehensive in scope (i.e. able to manage all of the Internet-enabled or WiFi-enabled devices within a home network), automated, and utilizes machine learning techniques to recognize complex patterns in data in order to provide actionable pieces of advice for optimizing the conditions affecting home internet and WiFi performance.

The output of the internet performance system in the present application may include a set of actionable pieces of advice, instructions, or informative tips as well as provided fixes or abilities to address, modify, resolve or repair certain identified conditions in an automated fashion. The actionable pieces of advice, instructions, or informative tips for optimizing the identified conditions affecting home internet and WiFi performance may be provided to a user from about as little as 16 seconds to about 5 minutes after the user first activates the internet performance system. Automated fixes may also be available to a user for implementation to address, modify, resolve, or repair any problematic conditions in the home network from about as little as 16 seconds to about 5 minutes after the user activates the internet performance system, for example by starting an application to activate the system. In another embodiment, the system may generate one or more pieces of advice for a partner, such as an internet service provider, IoT device provider, television service provider, that provides the partner with advice about a solution to an issue with the equipment provided by the partner in the premises of the customer.

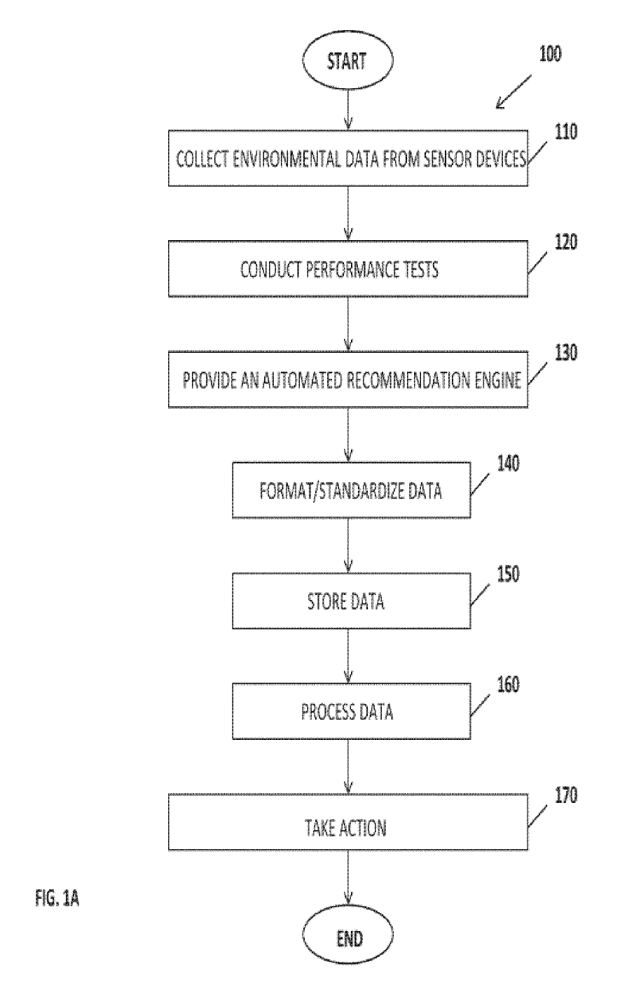

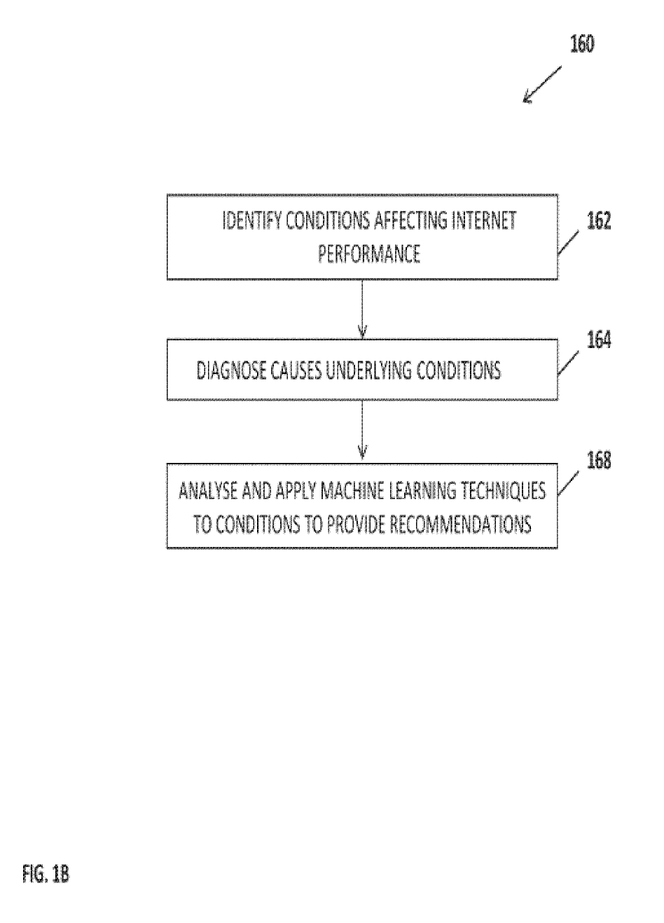

FIG. 1A is a flowchart showing a number of steps in an exemplary method 100. In a preferable embodiment, a user starts the process 100 by selecting to activate the internet performance system, which may be accessible to a user through an application that may be downloaded, for example, on a mobile device. The user may interact with the internet performance system using a graphical interface of the mobile or human interface device. Once the user starts the application as indicated by “START” in FIG. 1A, the internet performance system may collect network environmental data at 110 from one or more sensor devices, human interface devices, home internet or WiFi appliances, or other Internet-enabled or WiFi-enabled devices or components within or connected to the home network. The internet performance system may also initiate the conduction of performance tests to generate testing data or scores at 120 from one or more testing servers that may be housed on the Internet. The testing data or scores generated and collected by the system reflect various characteristics, properties, or indicators related to home internet or WiFi performance.

Data may be collected or generated from various sources, including but not limited to broadband routers and modems, WiFi access points, WiFi-enabled devices, or other Internet-enabled or WiFi-enabled devices or components as known in the art or yet to be developed. Additionally, empirical data may be sourced from devices that have a client that can interpret the request from a cloud-service and respond within the data structure format that is requested.

Network configuration and broadband statistics may be gathered using web protocols. WiFi statistics may be gathered using various protocols. Device data may be gathered using various zero-configuration and discovery protocols. The protocols for gathering empirical and other data are not limiting to the present disclosure and may comprise any protocol known in the art or yet to be developed. The expert system will process data acquired from the devices such as operating parameters related to WiFi frequency, channel bandwidth and signal strength. These values will be collected via manufacturer and industry standards such as TR-06, SNMP and various publicly known manufacturer APIs.

One or more testing servers may be housed on the Internet to conduct the performance tests and to simulate the end-to-end Internet experience, negating the deceptive high capacity “access network” throughput that many consumer facing tools provide. Output data from the one or more testing servers may be sent to an automated machine-learning advice engine or expert system for further processing and analysis.

Performance testing may include testing directed or related to: a home network's response; discovering or identifying devices within or connected to the home network; the quality of internet or WiFi connectivity; and the speed or bandwidth of uploading or downloading data. Each performance test may take from about as little as 3-5 seconds to as much as one minute to complete, preferably from about 5 seconds to about 30 seconds and more preferably from about 3 seconds to 15 seconds. Thus, the total time taken for the internet performance system to conduct the various performance tests for a home network may range from about 30 seconds to about 5 minutes, preferably from about 20 seconds to about 3 minutes, and more preferably from about 15 seconds to about 1 minute. The results of performance testing may be sent to and received by a human interface device for viewing by a user through a graphical interface. The Internet performance test is used to determine the quality of experience of multimedia applications such as video conferencing (FaceTime, skype) and VoIP (Whataspp, Skype) calls, streaming video (Netflix) and general internet conditions. Technical tests such as jitter measurements, packet loss, and throughput testing provide the insight necessary for deducing where there problem lies. The collection and uploading of the various data may be conducted simultaneously or in parallel with conduction of the performance tests. Thus, the results of the data collection may be completed and the results sent to and received by a human interface device for viewing by a user through a graphical interface at the same time as completion of the performance testing.

As shown in FIG. 1A, an automated machine-learning advice engine or expert system is provided at 130. In a preferable embodiment, the advice engine or expert system provided at 130 may comprise a modular, extensible data analytics platform that has the ability to use various machine learning techniques as known in the art or yet to be developed, selected during various stages of complexity of data sets during operation, coupled to consumer specific optimization techniques and broadband provider nuances. The human-expert defined advice engine or expert system provided at 130 may further leverage a combination of decision trees, learned methods and models, and historical data to inform the pieces of advice to output. In the system, various machine learning techniques are deployed across the expert system for the various components that make up the user experience. The most explicit technique that defines the core value proposition is the human trained classifier system. Experts train extensive data sets manually to train the classifier that provides the diagnostic advice to the human user of the partner portal or the consumer application.

The advice engine or expert system provided at 130 may interface with one or more sensor devices, human interface devices, home internet or WiFi appliances, or any other Internet-enabled or WiFi enabled device or component in the home network as known in the art or yet to be developed. In particular, home internet appliances such as modem routers and WiFi gateways may be able to interface to the advice engine or expert system provided at 130 via traditional web service methods and also in instances where the appliance is enrolled in a service from a broader system.

As shown in FIG. 1A, the advice engine or expert system provided at 130 may independently: (1) format the collected network environmental data and the generated testing data to a standardized format at 140; (2) store the formatted network environmental data and the formatted testing data at 150; and (3) process the formatted network environmental data, the formatted testing data, and previously stored historical data using machine learning techniques at 160.

In a preferable embodiment, at step 140, the advice engine or expert system provided at 130 may use a standardized data format for all test clients, testing parameters, and geographic locations to help ensure that global, regional, and city specific comparisons are done on a statistically meaningful basis. In addition, data normalization, standardization, and formatting may be performed in the internet performance system as part of the advice engine or expert system's operating procedure. This allows for increasing the number of sensors and appliances that data are sourced from over time.

The advice engine or expert system provided at 130 may use empirical data input from standardized data structures at points in the home network and from devices that have the ability to make connections to the Internet. The advice engine or expert system may process this data at 160 using various machine-learning techniques as known in the art or yet to be developed, for example, through a combination of decision trees, categorization methods, and heuristic methods against historical data. These techniques enable the advice engine or expert system to recognize complex patterns in the data in order to make inferences or decisions that provide for automated, environment-specific pieces of advice to optimize or improve a user's home internet and WiFi performance and quality of experience.

FIG. 1B is a flowchart showing further detail for the processing step 160 in the exemplary method 100 of FIG. 1A. More specifically, as shown in FIG. 1B, the advice engine or expert system provided at 130 in FIG. 1A performs a number of steps in processing the formatted network environmental data, the formatted testing data, and previously stored historical data. In particular, the advice engine or expert system may independently process the data it receives by: (1) identifying one or more conditions affecting internet or WiFi performance in the home network based on at least one of the processed network environmental, testing, and historical data at 162; (2) diagnosing one or more causes underlying the one or more conditions affecting internet or WiFi performance in the home network at 164; and (3) analyzing and applying machine learning techniques to the one or more conditions to provide one or more actionable pieces of advice to modify the one or more conditions at 168. For example, the actionable pieces of advice may be: 1) contact the ISP to increase bandwidth to the home if there are too many devices consuming the Internet link to the ISP; 2) change the default credentials of the home gateway for security purposes; and/or 3) change the WiFi frequency to improve performance in the home. The actionable pieces of advice may be sent to and received by human interface devices that may be classified for example as smartphones, computers, smart entertainment devices, wearable technologies such as smart watches, or other human interface devices or appliances as known in the art or yet to be developed. A preferable embodiment may implement a consumer-centric user-friendly service, where UX reformatting for the specific human interface device may be performed by the advice engine or expert system provided at 130.

The actionable pieces of advice may be provided to a user from about as little as 1-5 seconds after performance testing has been completed and the performance test results have been sent to and received by a human interface device. Thus, the actionable pieces of advice may be sent to and received by the human interface device and viewable by a user through a graphical interface from about 35 seconds to about 5.5 minutes, preferably from about 25 seconds to about 3.5 minutes, and more preferably from about 16 seconds to about 61 seconds after a user has activated the internet performance system, for example, by starting the application as indicated by “START” in FIG. 1A.

Additionally, actionable pieces of advice may be ranked or prioritized to reflect the predicted impact of a particular action associated with a recommendation on the home internet or WiFi performance. For instance, pieces of advice for taking actions that modify conditions and result in a larger predicted impact with a greater predicted improvement on home internet or WiFi performance relative to other pieces of advice may be given a higher ranking or priority. The output may then be generated as an ordered list, with the higher ranked pieces of advice having a higher priority and larger predicted impact appearing closer to the top of the list. Other criteria may also be used to order the actionable pieces of advice such as ease of implementation, provider, type of device or service, whether the recommendation calls for an automated or a manual fix, or any other criteria applicable to ordering or sorting the different pieces of advice.

Historical data may be used by the advice engine or expert system provided at 130 to learn and fine-tune its categorization model of characteristics that can be related to improvement and linked to direct or indirect user experience improvement and therefore improve the situational prioritization of the pieces of advice.

Finally, in the last step of the process 100 depicted in the exemplary embodiment of FIG. 1A, one or more actions may be taken at 170 corresponding to the one or more actionable pieces of advice to modify the one or more identified conditions to optimize or improve home internet or WiFi performance. An action to address, modify, repair, or resolve a condition or set of conditions affecting home internet or WiFi performance may be performed by a user following an actionable recommendation determined by the advice engine or expert system provided at 130, or the action may be automatically performed by the internet performance system. For example, home internet appliances such as modem routers and WiFi gateways may be able to interface to the advice engine or expert system via traditional web service methods and also in instances where the appliance is enrolled in a service from a broader system, where automated fixes are applied through an approval service independent from the internet performance system. The automated fixes may be sent to and received by a human interface device and viewable by a user through a graphical interface from about 35 seconds to about 5.5 minutes, preferably from about 25 seconds to about 3.5 minutes, and more preferably from about 16 seconds to about 61 seconds after a user has activated the internet performance system, for example, by starting the application as indicated by “START” in FIG. 1A.

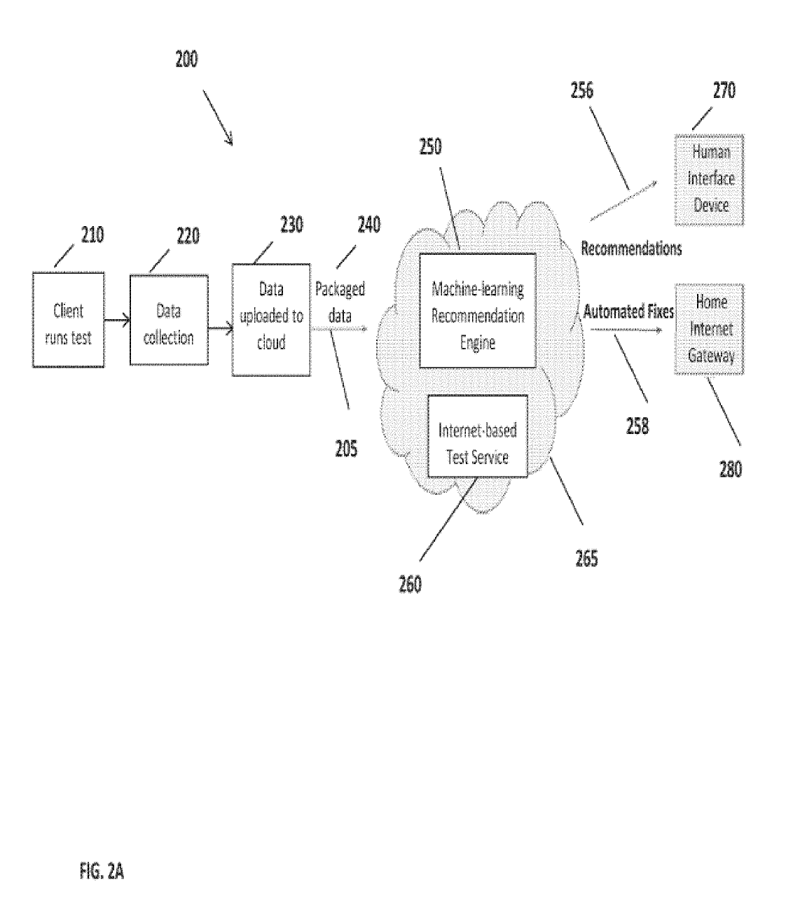

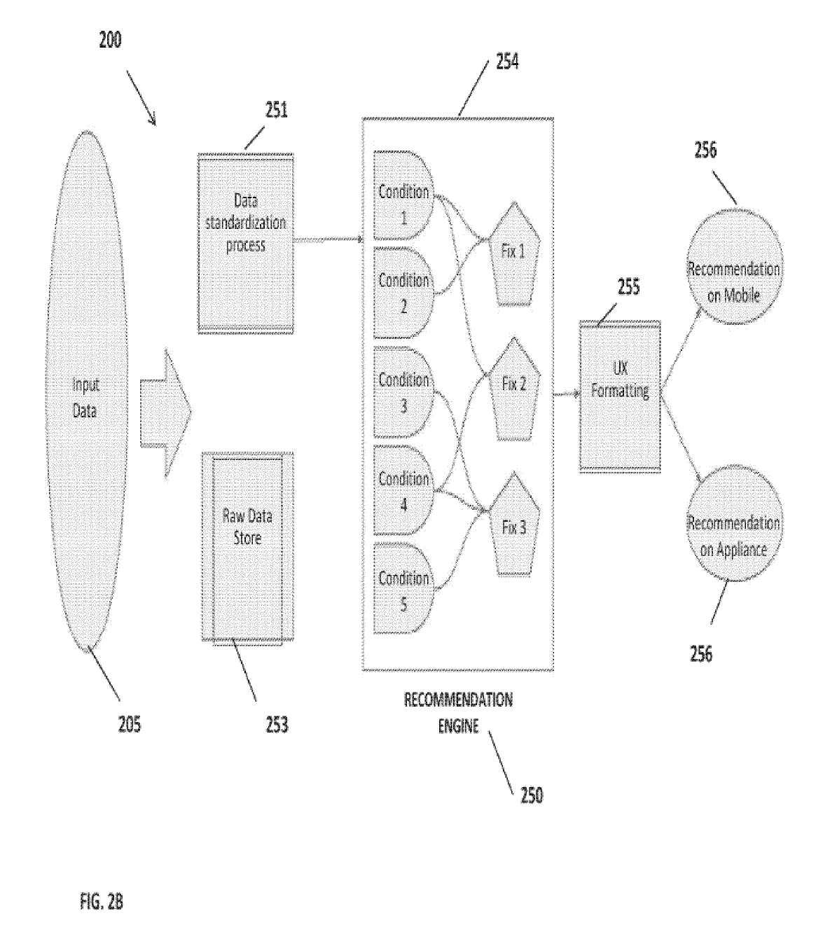

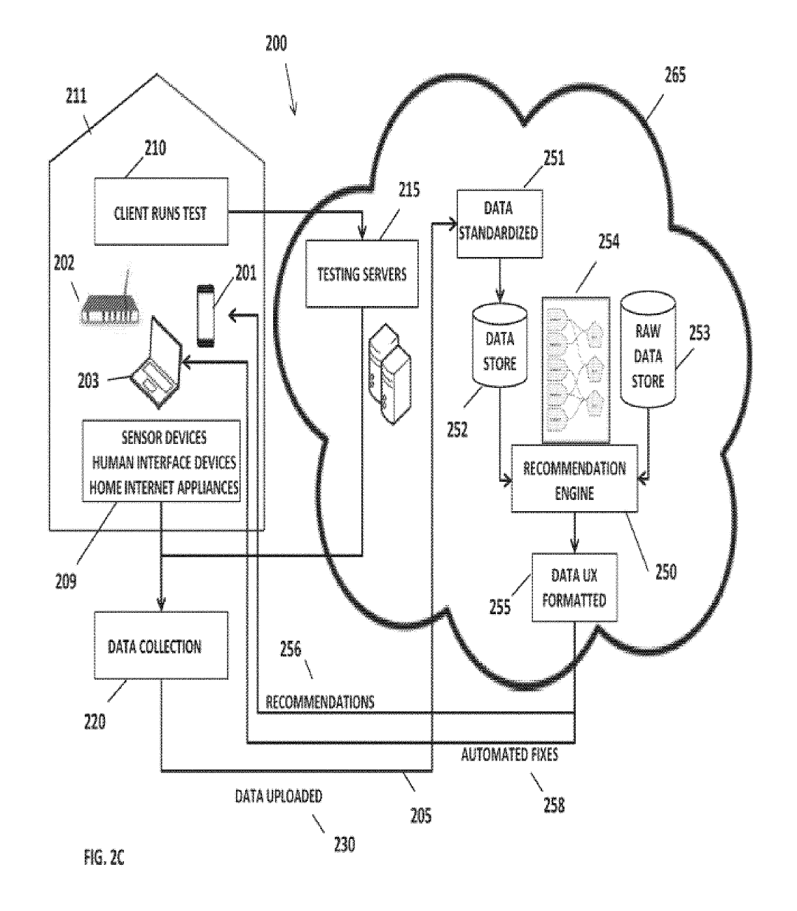

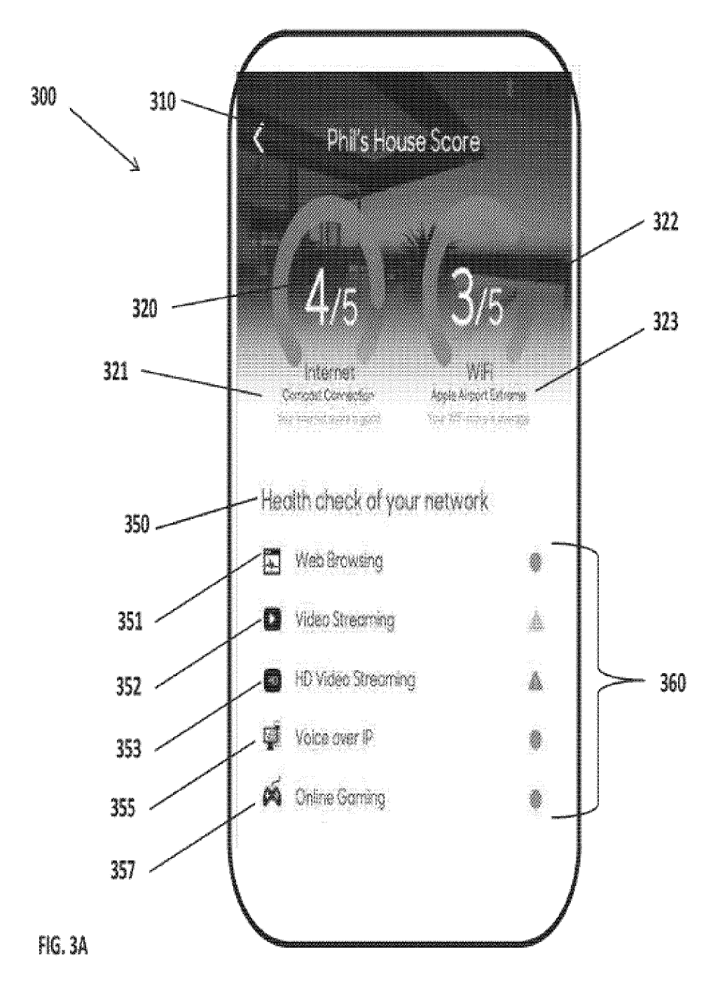

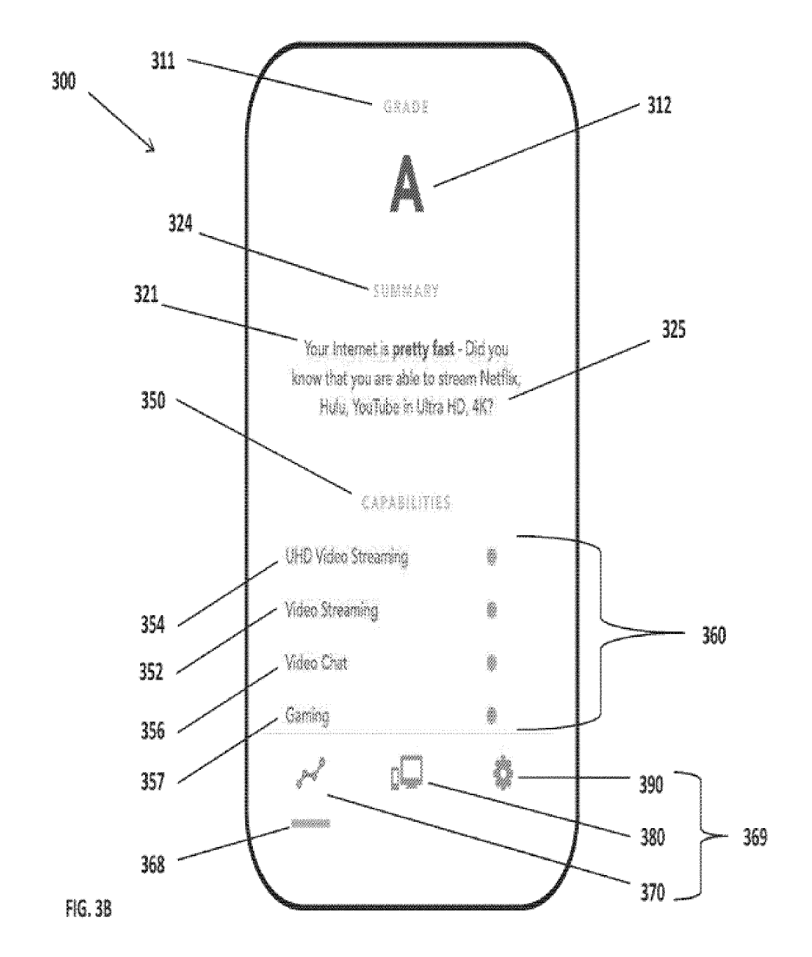

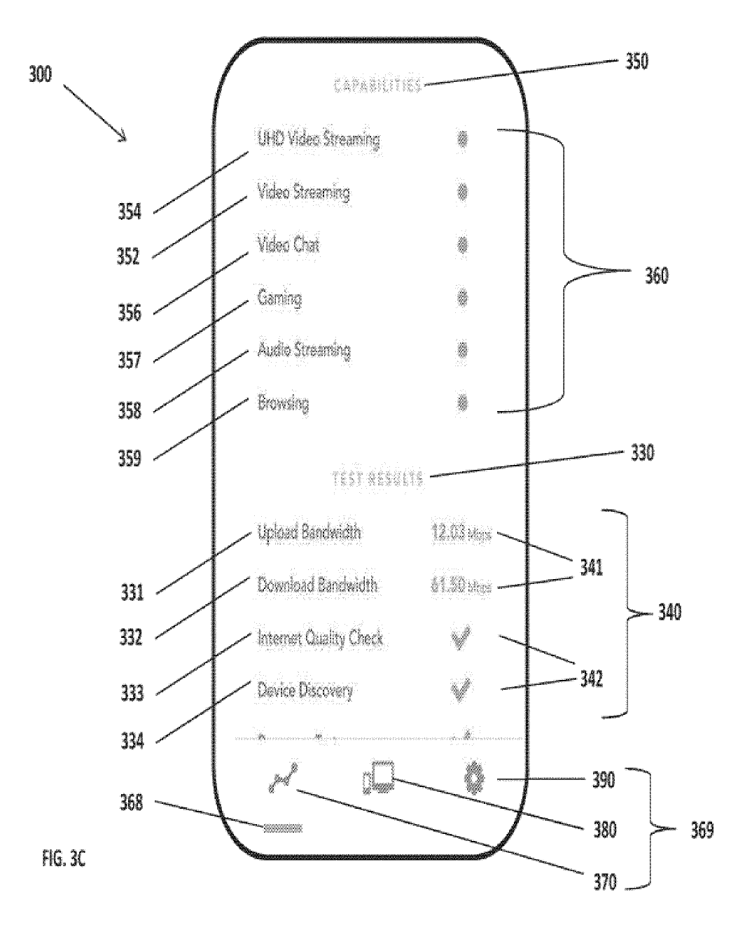

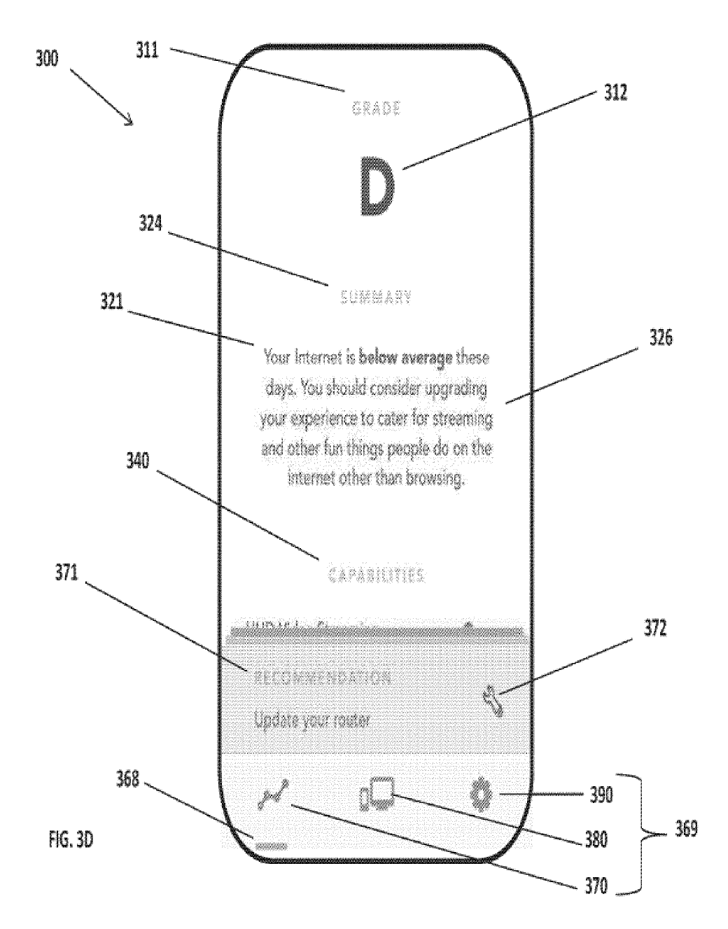

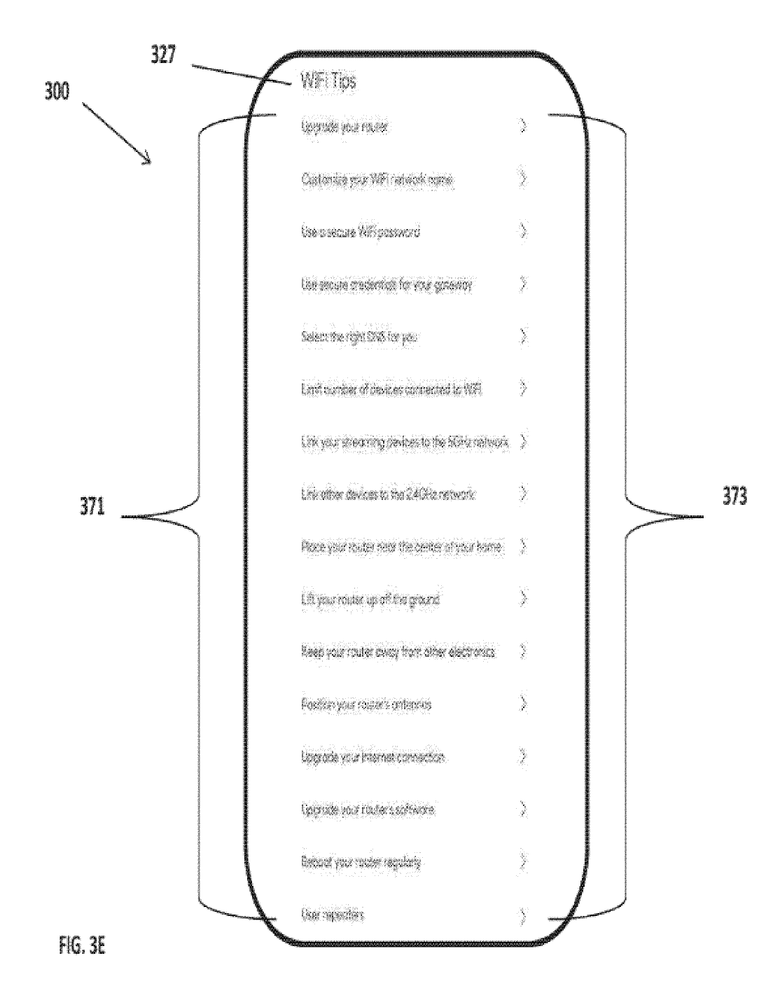

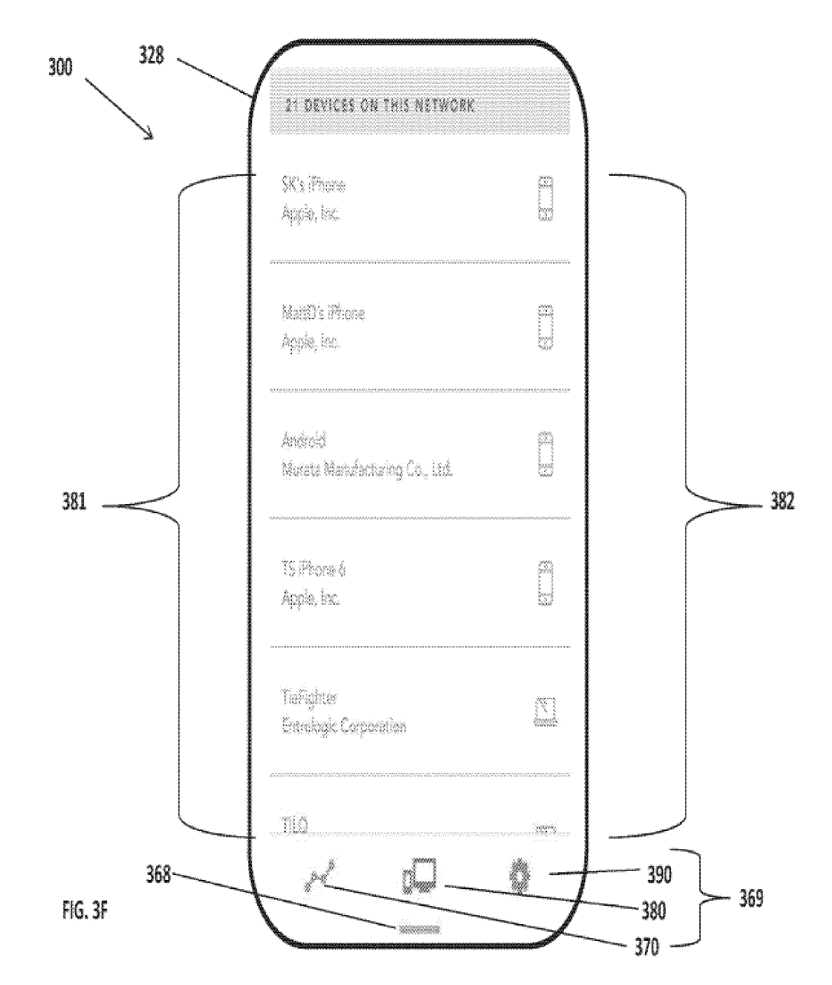

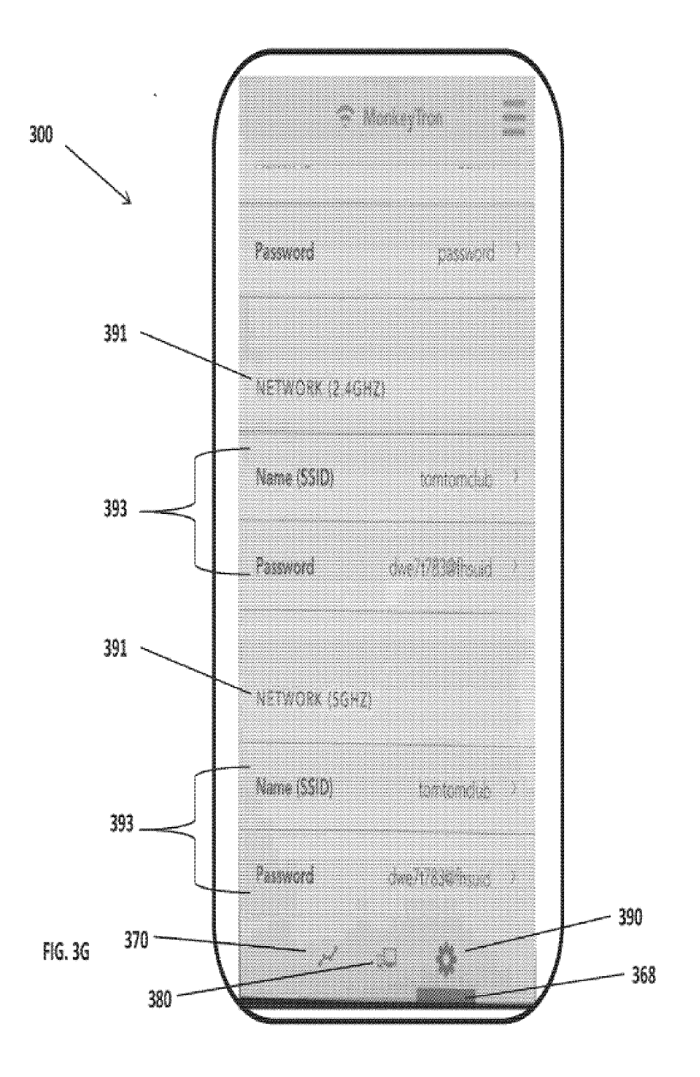

FIGS. 2A-2C are block diagrams showing a number of functional components of an exemplary embodiment of a cloud-based internet performance system 200. As described above with respect to FIG. 1A, a user activates the internet performance system 200, which may be accessible to the user through an application that may be downloaded, for example, on a mobile device 201. The user may interact with the internet performance system using a graphical interface of the mobile or human interface device, discussed in more detail with respect to FIGS. 3A-3E.

Once the user starts the application, the internet performance system 200 may initiate the running of performance tests to generate testing data or scores at 210 from one or more testing servers 215. Performance testing may include testing directed or related to: a home network's response; discovering or identifying devices within or connected to the home network; the quality of internet or WiFi connectivity; and the speed or bandwidth of uploading or downloading data. Each performance test may take from about as little as 3-5 seconds to as much as one minute to complete, preferably from about 5 seconds to about 30 seconds and more preferably from about 3 seconds to 15 seconds. Thus, the total time taken for the internet performance system to conduct the various performance tests for a home network may range from about 30 seconds to about 5 minutes, preferably from about 20 seconds to about 3 minutes, and more preferably from about 15 seconds to about 1 minute. The results of performance testing may be sent to and received by a human interface device for viewing by a user through a graphical interface.

The one or more testing servers may be housed on the Internet 265 and may simulate the end-to-end Internet experience, negating the deceptive high capacity “access network” throughput that many consumer facing tools provide. Output data from the one or more testing servers may be sent to an automated machine-learning advice engine or expert system 250 for further processing and analysis. In a preferable embodiment, performance testing may be provided by an Internet-based Test Service 260. The testing data or scores generated and collected by the system at 220 reflect various characteristics, properties, or indicators related to home internet or WiFi performance.

The internet performance system 200 may also collect network environmental data at 220 from one or more sensor devices 209, human interface devices 209, home internet or WiFi appliances 209, or any other Internet-enabled or WiFi enabled device or component in the home network 211 as known in the art or yet to be developed. Data may be collected or generated from various sources, including but not limited to broadband routers and modems 202, WiFi access points (not shown), and WiFi-enabled devices 201 and 203. Additionally, empirical data may be sourced from devices that have a client that can interpret the request from a cloud-service and respond within the data structure format that is requested. Network configuration and broadband statistics may be gathered using web protocols. WiFi statistics may be gathered using various protocols. Device data may be gathered using various zero-configuration and discovery protocols. The protocols for gathering empirical or other data are not limiting to the present disclosure and may comprise any protocol known in the art or yet to be developed. These various data are uploaded at 230 to the internet performance system 200 as packaged data 240. The collection and uploading of the various data may be conducted simultaneously or in parallel with conduction of the performance tests. Thus, the results of the data collection may be completed and the results sent to and received by a human interface device for viewing by a user through a graphical interface at the same time as completion of the performance testing.

As shown in FIGS. 2A-2C, the internet performance system 200 comprises a machine-learning advice engine or expert system 250. In a preferable embodiment, the advice engine or expert system may be cloud-based, and may further comprise a modular, extensible data analytics platform that has the ability to use various machine learning techniques as known in the art or yet to be developed, selected during various stages of complexity of data sets during operation, coupled to consumer specific optimization techniques and broadband provider nuances. The human-expert defined advice engine or expert system 250 may further leverage a combination of decision trees or other learned methods and models 254, and historical data 253 to inform the pieces of advice 256 to output. As described above, the input data 205 to the advice engine or expert system 250 comprises network environmental data generated by sensor devices 209 (e.g. mobile phones, appliances, routers, gateways) and empirical data (e.g. network statistics, performance indicators) that may be generated by testing servers. Some examples of the conditions that may be identified by the system and method may include Internet congestion, poor home WiFi setup, congested WiFi spectrum and/or poor device placement in home. As described above with respect to FIG. 1A, the advice engine or expert system 250 may independently: (1) format the collected network environmental data and the generated testing data to a standardized format at 251; (2) store the formatted network environmental data and the formatted testing data at 252; and (3) process the formatted network environmental data, the formatted testing data, and previously stored historical data using machine learning techniques 254.

The advice engine or expert system 250 may use a standardized data format provided at 251 to normalize or standardize the data for all test clients, testing parameters, and geographic locations to help ensure that global, regional, and city specific comparisons are done on a statistically meaningful basis. In addition, data standardization, normalization, and formatting at 251 may be performed in the cloud-based internet performance system 200 as part of the advice engine or expert system's operating procedure to provide a uniform data structure for detailed computation. This allows for increasing the number of sensors, appliances, and other devices 209 that data are sourced from over time.

The advice engine or expert system 250 may interface with one or more sensor devices 209, human interface devices 209, or home internet or WiFi appliances 209, or any other Internet-enabled or WiFi enabled device or component in the home network 211 as known in the art or yet to be developed. In particular, home internet appliances such as modem routers 202 and internet or WiFi gateways 280 may be able to interface to the advice engine or expert system 250 via traditional web service methods and also in instances where the appliance is enrolled in a service from a broader system.

The advice engine or expert system 250 may use empirical data input from standardized data structures at points in the home network 211 and from devices that have the ability to make connections to the Internet 265. The advice engine or expert system 250 may process this data using various machine-learning techniques 254 as known in the art or yet to be developed, for example, through a combination of decision trees, categorization methods, and heuristic methods against historical data that may be stored in a raw data store 253. These and other machine learning techniques enable the advice engine or expert system 250 to recognize complex patterns in the input data 205 in order to make inferences or decisions that provide for automated, environment-specific pieces of advice 256 to optimize or improve a user's home internet and WiFi performance and quality of experience.

The advice engine or expert system 250 may perform a number of steps in processing the formatted network environmental data, the formatted testing data, and previously stored historical data. In particular, the advice engine or expert system 250 may independently process the data it receives by: (1) identifying one or more conditions affecting internet or WiFi performance in the home network 211 based on at least one of the processed network environmental, testing, and historical data; (2) diagnosing one or more causes underlying the one or more conditions affecting internet or WiFi performance in the home network 211; and (3) analyzing and applying machine learning techniques 254 to the one or more conditions to provide one or more actionable pieces of advice 256 to modify the one or more conditions.

Formatted network environmental and testing data may be stored in data store 252, while historical data may be stored in raw data store 253. Alternatively, all of the data used by the advice engine or expert system 250 may be stored in different locations or components or in the same location or storage component as known in the art or yet to be developed.

The actionable pieces of advice 256 may be sent to and received by human interface devices 270 that may be classified for example as smartphones 201, computers 203, smart entertainment devices (not shown), wearable technologies such as smart watches (not shown), or other devices or appliances as known in the art or yet to be developed. A preferable embodiment may implement a consumer-centric user-friendly service, where UX reformatting 255 for the specific human interface device may be performed by the advice engine or expert system 250.

The actionable pieces of advice 256 may be provided to a user from about as little as 1-5 seconds after performance testing has been completed and the performance test results have been sent to and received by one or more human interface devices 270. Thus, the actionable pieces of advice 256 may be sent to and received by one or more of human interface devices 270 and viewable by a user through a graphical interface from about 35 seconds to about 5.5 minutes, preferably from about 25 seconds to about 3.5 minutes, and more preferably from about 16 seconds to about 61 seconds after a user has activated the internet performance system, for example by starting the application.

In a preferable embodiment, the actionable pieces of advice 256 may be ranked or prioritized to reflect the predicted impact of a particular action associated with a recommendation on the home internet or WiFi performance. For instance, pieces of advice for taking actions that modify conditions and result in a larger predicted impact with a greater predicted improvement on home internet or WiFi performance relative to other pieces of advice may be given a higher ranking or priority. The output may then be generated as an ordered list, with the higher ranked pieces of advice with a higher priority and larger predicted impact appearing closer to the top of the list. Additionally, other criteria may also be used to order the actionable pieces of advice such as ease of implementation, provider, type of device or service, whether the recommendation calls for an automated or a manual fix, or any other criteria applicable to ordering or sorting the different pieces of advice.

In addition, historical data 253 may be used by the advice engine or expert system 250 to learn and fine-tune its categorization model 254 of characteristics that can be related to improvement and linked to direct or indirect user experience improvement and therefore improve the situational prioritization of the pieces of advice.

Accordingly, the system and method disclosed in the present application provides a user with automated, environment-specific, actionable pieces of advice that are tailored, customized, and prioritized to optimize and improve a user's quality of experience.

With respect to the process 100 depicted in the exemplary embodiment of FIG. 1A, remedial action to institute change on a home network appliance 209 or other Internet-enabled or WiFi-enabled device may either be automated or performed by a human based on the specific information and instruction provided in the recommendation. For example, home internet appliances 209 such as modem routers and internet or WiFi gateways 280 may be able to interface to the advice engine or expert system 250 via traditional web service methods and also in instances where the appliance is enrolled in a service from a broader system, where automated fixes 258 are applied through an approval service independent from this internet performance system.

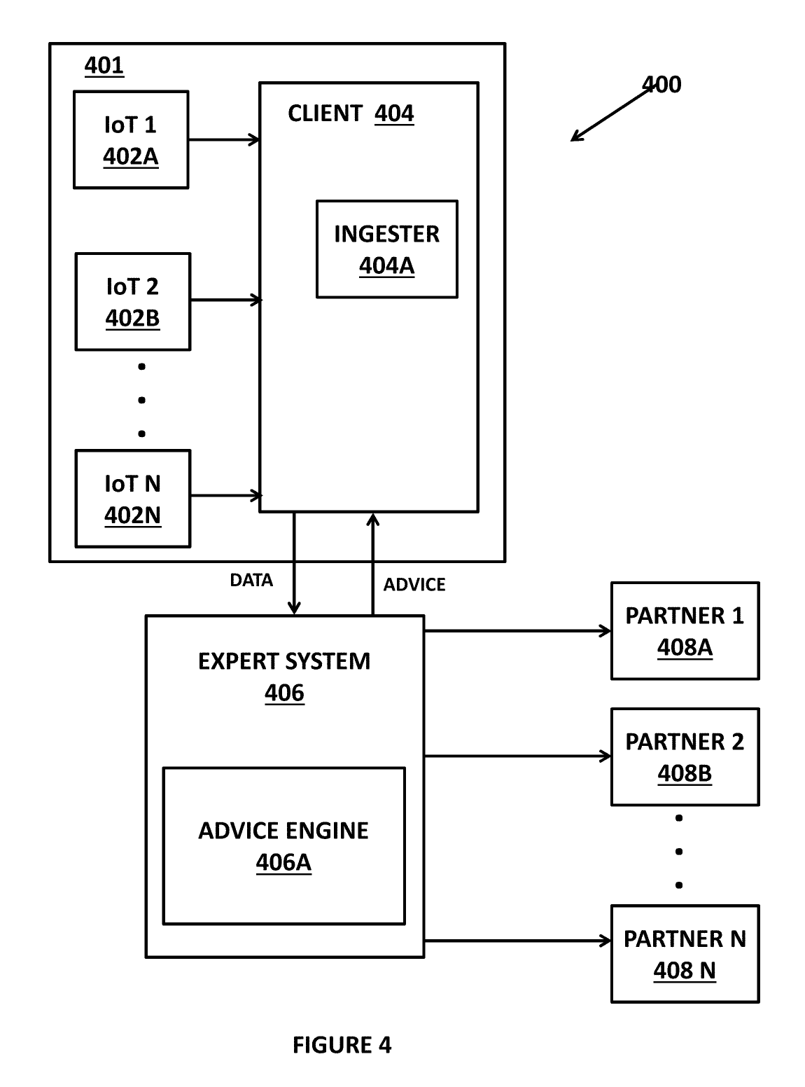

As described above, a user may initiate the internet performance system through an application that may be downloaded, for example, on a mobile device or other human interface device as known in the art or yet to be developed. In particular, the user may interact with the internet performance system using a graphical interface of the mobile or human interface device an exemplary embodiment of which is depicted in FIGS. 3 and 4.

In a preferable embodiment, after the user initiates the internet performance system and performance testing has been completed by the system, a graphical interface 300 may be configured to provide the user with the results. Two examples of a graphical interface 300 are shown in FIGS. 3A-3B.

An overview of the internet and WiFi performance of the user's home network may be provided on a graphical interface 300, as shown in FIG. 3A, which may include a House Score 310 comprising scores 320 and 322 that rate the performance of a home internet connection and a WiFi connection respectively. A performance score may be quantitative, for example using a numerical rating on a numerical scale. In particular, FIG. 3A shows that score 320 has a numerical rating of 4/5 while score 322 has a numerical rating of 3/5. In addition, a qualitative rating 321 and 323 may be provided representing the quality of internet and WiFi performance respectively. For example, as shown in FIG. 3A, internet connectivity has a qualitative rating 321 of good while WiFi connectivity 323 has a qualitative rating of average.

Alternatively, a Grade 311 may be determined for internet or WiFi performance as shown in FIG. 3B. The grade 311 may be a letter grade 312 such as “A,” “B,” or “C” or it may be a numerical grade using a numerical scale as shown in FIG. 3A. FIG. 3B also shows that a Summary 324 may be provided that includes not only a qualitative rating 321 (e.g. pretty fast, fast, pretty slow, very good, good, average, below average) representing the quality of a home network's internet connection, but also Network Capability Information 325 to inform the user of the home network's capabilities. As shown in FIG. 3B, network capability information may include the ability to stream particular services or applications, such as Netflix, Hulu, and YouTube, and the type of streaming or network service available such as Ultra HD and 4K.

As shown in FIGS. 3B-3D, a user may access or navigate to different pages or views of the graphical interface 300 that provide additional interactions with the internet performance system by selecting or tapping on a Navigational Element 369 shown as a graphical symbol, icon, or text that represents a different page or view. Different page views of the graphical interface 300 may be used, for example, to show a Summary View 370, Device View 380, or Configuration View 390 respectively of the internet performance system. An exemplary embodiment shown in FIG. 3B shows that the user has selected the Summary View 370 (as indicated by a Selection Indicator 368 located below the Summary View symbol) providing the graphical interface Summary Page or View 300 as shown on FIGS. 3B-3D. The Selection Indicator 368 may comprise highlighting the Navigational Element 369 selected by the user, or any other indicator means as known in the art or yet to be developed to indicate that a particular page or view of the graphical interface has been selected.

FIG. 3C shows the graphical interface of FIG. 3B where the user has scrolled down the Summary View 370 to show additional information contained on the page. As shown in FIGS. 3A-3C, a health check or summary of capabilities 350 of the user's home network may be provided that comprises various internet or WiFi-dependent capabilities such as for example Web Browsing 351, Video Streaming 352, HD Video Streaming 353, UHD Video Streaming 354, Voice over IP 355, Video Chat 356, Gaming or Online Gaming 357, Audio Streaming 358, and Browsing 359. A graphical representation 360 indicating how the current home network conditions may support the performance of each capability or activity may also be provided.

The graphical representation 360 may be an icon, symbol, or other indicator that indicates the quality or state of the network's ability to support each capability. For example, in a preferable embodiment, the indicator may comprise a symbol or object with a different shape, such as a circle, square, or triangle to represent good, average, or below average performance respectively for each capability listed under the health check or summary of capabilities 350. The indicator may further comprise the use of different colors, such as green for good, yellow for average, and red for below average performance, or any other means as known in the art or yet to be developed to indicate a different quality or state for each capability.

In addition, as shown in FIG. 3C, a summary of the performance test results (Test Results 330) conducted by the internet performance system may be provided and accessed through the graphical interface 300. Various tests may be conducted and results provided, including for example a Response Test (not shown) directed to test a home network's response; a Device Discovery Test 334 for discovering or identifying devices within or connected to the home network; an Internet Quality Check 333 for measuring the quality of internet or WiFi connectivity; and Upload Bandwidth 331 and Download Bandwidth 332 tests for measuring the speed or bandwidth of uploading or downloading data. Each performance test may take from about as little as 3-5 seconds to as much as one minute to complete, preferably from about 5 seconds to about 30 seconds and more preferably from about 3 seconds to 15 seconds. Thus, the total time taken for the internet performance system to conduct the various performance tests for a home network may range from about 30 seconds to about 5 minutes, preferably from about 20 seconds to about 3 minutes, and more preferably from about 15 seconds to about 1 minute. The results of performance testing may be sent to and received by a human interface device for viewing by a user through a graphical interface.

In a preferable embodiment, the results of performance testing may be presented as Performance Test Scores 340, which may be Numerical Scores 341, for example in megabits per second (Mbps) for the Upload and Download Bandwidths 331 and 332 respectively, or as a Qualitative Scores 342, which may comprise symbols or quality indicators such as checkmarks.

FIG. 3D shows the graphical interface of FIG. 3B depicting an output from an embodiment of a machine-learning advice engine or expert system. In particular, once the advice engine or expert system has processed the network environmental and testing data, one or more actionable pieces of advice 371, may be provided for example as determined at 168 and as described with respect to FIG. 1B above. The internet performance system may be configured to display the one or more actionable pieces of advice, or may display only a select number of one or more actionable pieces of advice 371 having the largest predicted impact or greatest predicted improvement on problematic conditions affecting home internet and WiFi performance. In addition, the Summary 324 may include Suggestions 326 having further details regarding the one or more actionable pieces of advice 371 currently being displayed. As shown in FIG. 3D, the one or more actionable pieces of advice 371 may be displayed or pop up as a window appearing on the Summary View 370. Additionally, a Resolution Element 372 may be displayed with the one or more actionable pieces of advice 371 that, when selected by a user, activates an action to address, modify, repair or resolve the problematic condition associated with the recommendation. The action may be automated or may comprise a set of instructions to be manually implemented by a user. In a preferable embodiment, the internet performance system may automatically take an action to modify or repair a condition such as automatically reconfiguring a sensor device, human interface device, or a home internet appliance to improve the functionality of internet or WiFi connectivity in the home network. The Resolution Element 372 may be represented by a symbol, icon, or text indicative of the type of action or resolution to be implemented.

Alternatively, FIG. 3E displays a different page or view of an embodiment of the graphical interface shown in FIG. 3A, wherein a list of actionable pieces of advice 371 is displayed as an ordered list of tips, which may be for example WiFi Tips 327, prioritized according to various criteria. A user may tap or select an actionable recommendation 371 on the list of WiFi Tips 327 as indicated by the arrows 373 located alongside each actionable recommendation 371 to obtain further details about how to execute or take action on any particular recommendation.

Actionable pieces of advice 371 may include text, actions, or images. Actions may be links to another website, for example, links to a merchant to purchase a new or updated device, or links to a configuration page for a home appliance in order to modify its settings. As described above, these actions may be automated or may be executed manually by the user according to instructions provided in the details.

In a preferable embodiment, the internet performance system may automatically take an action to modify or repair a condition such as automatically reconfiguring a sensor device, human interface device, or a home internet appliance to improve the functionality of internet or WiFi connectivity in the home network.

Actionable pieces of advice 371 and Resolution Elements 372 may be provided to a user from about as little as 1-5 seconds after performance testing has been completed and the performance test results have been sent to and received by a human interface device. Thus, actionable pieces of advice 371 and resolution elements 372 may be sent to and received by the human interface device and viewable by a user on graphical interface 300 from about 35 seconds to about 5.5 minutes, preferably from about 25 seconds to about 3.5 minutes, and more preferably from about 16 seconds to about 61 seconds after a user has activated the internet performance system, for example by starting the application.

FIG. 3F shows the graphical interface 300 of FIG. 3B wherein a user has selected the Device View 380 from the set of Navigation Elements 369. As shown in FIG. 3F, the Device View 380 provides a Device Summary 328 that comprises a list of devices (along with the number of devices) within or connected to the home network. Each of the home network devices 381, which may comprise one or more sensor devices, human interface devices, or home internet appliances 209 as shown in FIG. 2C, may be associated with a Network Device Element 382, which may be represented by a symbol, icon, or text indicative of the type or nature of its associated network device.

The data informing or used to generate the Device View 380 may be collected during the data collection step at 110 as described with respect to FIG. 1A. The collection and uploading of this data may be conducted simultaneously or in parallel with conduction of the performance tests. Thus, the results of the data collection may be completed and the results sent to and received by a human interface device for viewing by a user through the Device View 180 at the same time as completion of the performance testing.

FIG. 3G shows the graphical interface 300 of FIG. 3B wherein a user has selected the Configuration View 390 from the set of Navigation Elements 369. As shown in FIG. 3G, the Configuration View 390 provides various Configuration Devices 391, which may include for example various routers, gateways, networks, or other sensor devices, human interface devices, or home internet appliances as known in the art or yet to be developed that are capable of being configured. Configuring one or more of the Configuration Devices 391 may require a Name/Identification 393 having an associated password. In addition, configuring or reconfiguring one or more Configuration Devices 391 may be performed as an automated fix by the internet performance system or may be implemented manually by a user following an actionable recommendation via the Configuration View 390 of the graphical user interface 300.

In a preferable embodiment, the internet performance system may automatically take an action to modify or repair a problematic home network condition such as automatically reconfiguring a sensor device, human interface device, or a home internet appliance to improve the functionality of internet or WiFi connectivity in the home network.

FIG. 4 illustrates another embodiment of the system 400 that may be used to provide data to third party partners. In this embodiment, the problem being addressed is that third party partners, such as an internet service provider (ISP), printer company, television company, cable company, etc., do not have visibility into each customer's house and the various equipment, such as a television, a cable box, a wireless router, etc. that may be malfunctioning or functioning at less than full capacity. Each of the pieces of equipment may be an internet of things (IoT) device since each of these devices have an internet connection. When a customer has an issue with their service, the third party partner has to try to diagnose the problem without the benefit of any data about the device and then often has to send a technician in a truck to the house to diagnose and resolve the problem. In a significant number of cases, the technician who is at the house determines that the resolution of the problem is very simple, such as locating the wireless router password, and could have been resolved without the costly expense of sending the technician and the truck to the house or site. The system and method in FIG. 4 provides a technical solution to the above problem using a machine learning based advice engine that receives data from each IoT device in the house or site, performs machine learning operations on that data and generates advice for the consumer. The system may also generate data for each third party partner, based on the data from the IoT devices, which permits each third party partner to forego the costly sending of a truck and technician to the house or site when the customer problem may be resolved over the phone or by some other method. Alternatively, the advice engine may conform for a partner that a truck needs to be sent to a particular consumer. In both cases, the system 400 provides a better consumer experience in that the provider/partner is able to accurately diagnose an issue and provide advice to the consumer that may include sending a truck to address a particular problem, such as a problem with a wireless router. Thus, the system and method provides a technical solution using at least the machine learning advice engine to the above problems.

FIG. 4 shows the system 400 that may have one or more elements/components that make up the system for providing advice to a consumer and/or to a partner/service provider such as an internet service provider, a cable television provider and the like. The system 400 may include one or more consumer premises 401 in which each consumer premises may be a residential premises, a commercial premises or any other premises that had IoT devices that may be analyzed by the system 400. Each consumer premises may have one or more internet of things (IoT) devices 402, such as IoT devices 402A, 402B, . . . , 402N wherein each IoT device may be a device that has an internet connection. For example, each IoT device 402 may be a wireless router provided by an internet service provider, a thermostat, an electronic door lock or a home security system element provided by a partner, a television and the like. For example, a data set collected for each device may include {Device Name, Device Mac Address, Device IP Address, Device Make, Device Model, Device Serial number, Printer Paper Size, Paper Empty, Duplex Capability}.

The data from each IoT device 402 may be received by a client computer 404 that is also resident in the consumer premises. The client computer 404 may be a smartphone device, such as an Apple iPhone or Android OS based device, a tablet computer, a personal computer, a laptop computer, a terminal and the like that has at least a processor, memory, a display for displaying the advice provided to the consumer and connectivity circuits that allow the client computer to communicate with an expert system 406. The client computer 404 may execute an application, a mobile application or browser that permits the consumer to interact with the system, such as shown above in example user interfaces shown in FIGS. 3A-3G.

The client computer application may include an ingester component 404A that may receive/collect the data from each IoT device 402 and standardize that data so that it may be stored. The ingester component 404A shown in FIG. 4 may perform the same operations as the data collection 220 and data standardized 251 processes shown in FIG. 2C. In an alternate embodiment, the ingester component 404A may be implemented/hosted by/on the expert system 406.

The client 404 may communicate the data from the IoT devices 402 (raw data or standardized data depending on the implementation of the system) to an expert system 406. The expert system may be implemented using cloud resources. The expert system may generate one or more pieces of advice based on the IoT device 402 data and communicate the advice back to the client 404 for consumer-focused advice and/or communicate advice to one or more partners 408, such as a partners 408A, 408B, . . . , 408N, so that the one or more partners can diagnose an issue with an IoT device 403 at the premises. For example, the system may generate advice to the consumer about how to reconfigure their wireless router or other IoT device 402 to improve the performance for the user. As another example, the system may generate a piece of advice for an internet service provider partner 408B that analyzes the wireless router at the consumer premises and confirms that the internet service provider partner 408B needs to send a truck and technician to the premises to resolve an issue with the wireless router of the consumer. As yet another example, the system may generate a piece of advice for an internet service provider partner 408B that analyzes the wireless router at the consumer premises and confirms that the internet service provider partner 408B does not need to send a truck and technician to the premises to resolve an issue with the wireless router of the consumer and the internet service provider partner 408B can resolve the consumer issue via a telephone call, chat session, via email, etc.

The expert system 406 shown in FIG. 4 may function as described above with reference to FIG. 2B. The expert system 406 may also have the additional elements (for example the testing service/tester servers, the data store and the data formatter) shown in FIGS. 2A and 2C described above. The expert system 406 may have an advice engine 406A that receives the data from each IoT device 402 and generates the one or more pieces of advice for the consumer(s) and/or the partner(s). As described above, the advice engine 406A may be implemented using machine learning and machine learning algorithms as described above.

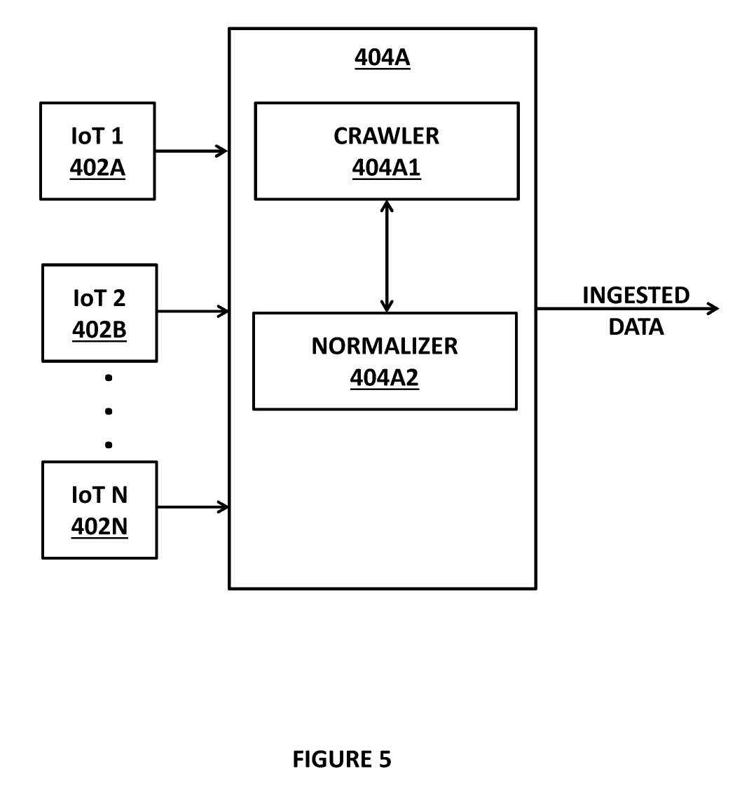

FIG. 5 illustrates more details of the ingester component 404a shown in FIG. 4. In one embodiment, the ingester component 404A may be resident in the client computer as shown in FIG. 4. In another embodiment, the ingester component 404A may be resident in the expert system/cloud system as shown in FIG. 2C. The ingester component 404A may include a crawler component 404A1 that collects the data about each IoT 402 (using the data collection process 220 as described above). In one implementation, the crawler component may poll each IoT device when the user imitates the process. However, the crawler component may also be configured to periodically poll each IoT device. The ingester component 404A also may include a normalizer 404A2 that normalizes/standardizes the data from each of the IoT devices 402 since each IoT device 402 may have a different data format. The normalizer 404A2 may use the data standardizing process 251 as described above.

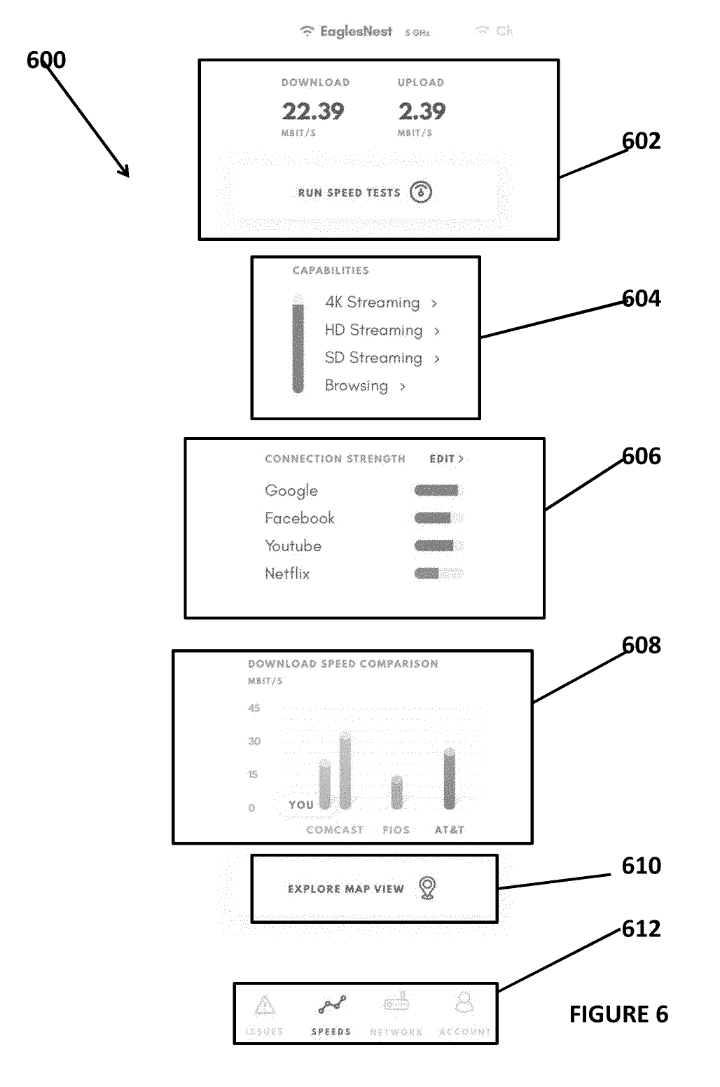

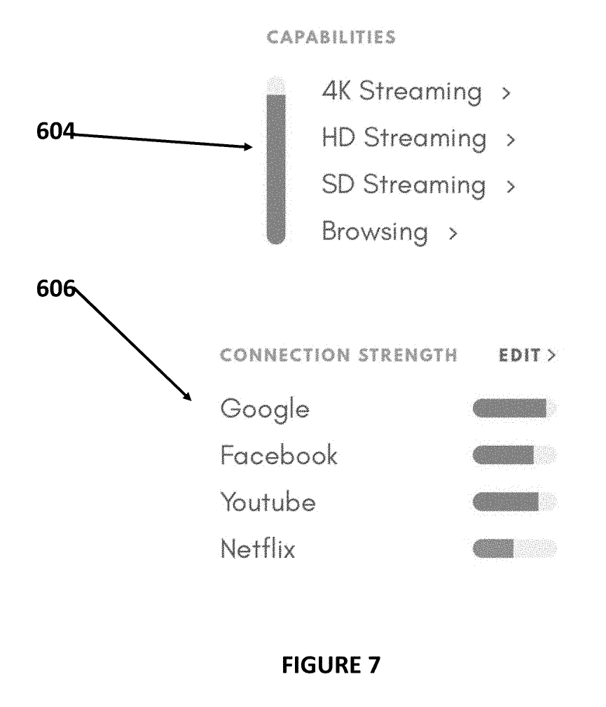

FIG. 6 illustrates an example of a graphical interface 600 generated in an exemplary embodiment that shows the data about a network of a particular user based on the collected data wherein the system may generate a similar user interface for each user of the system. The user interface may include a speed test portion 602 that displays an upload speed and a download speed of the network at a particular time and a button to perform a new speed test. The user interface also may include a capabilities portion 604 that displays whether different capabilities (browsing, standard defmition (SD) streaming, high defmition (HD) streaming and 4K streaming in the example in FIG. 6) are currently available as shown by the status bar. In the example in FIG. 6, the user has all of the capabilities except 4K streaming which requires the most bandwidth of the capabilities. The user interface also may include a connection strength portion 606 that shows a connection strength for various websites (Google, Facebook, YouTube and Netflix in the example in FIG. 6) wherein the various sites displayed are configurable by the user. For each site, the portion 606 shows a status bar with the relative connection strength. In the example in FIG. 6, the Netflix connection has the lowest connection strength. The portions 604 and 606 are shown in more detail in FIG. 7.

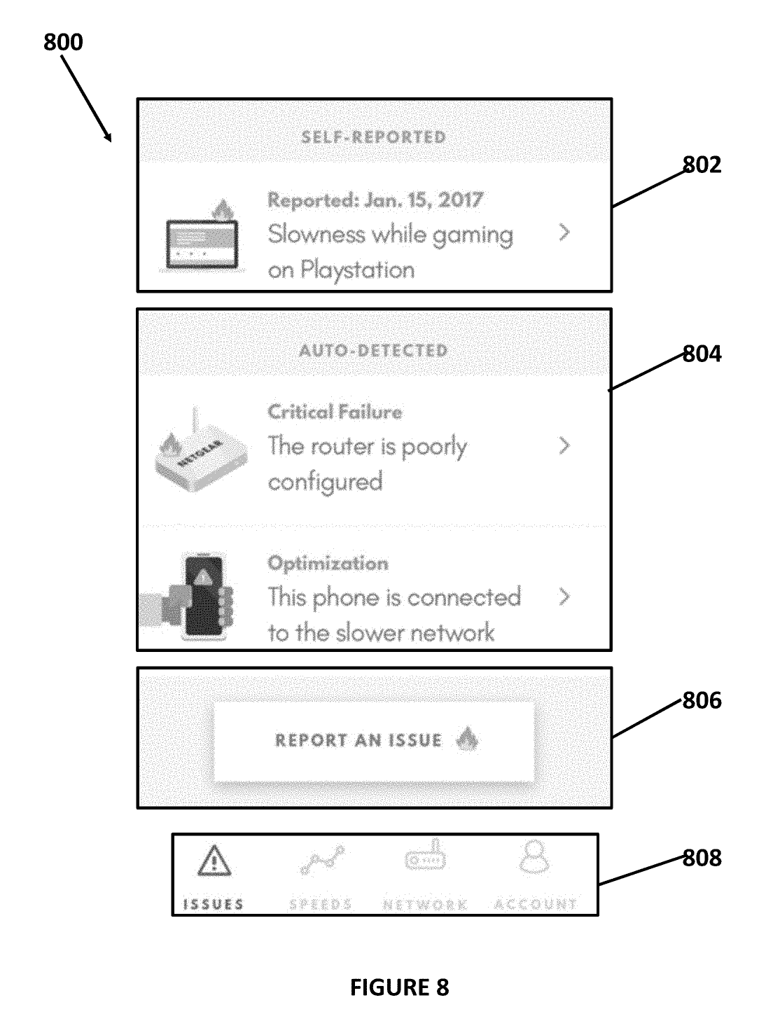

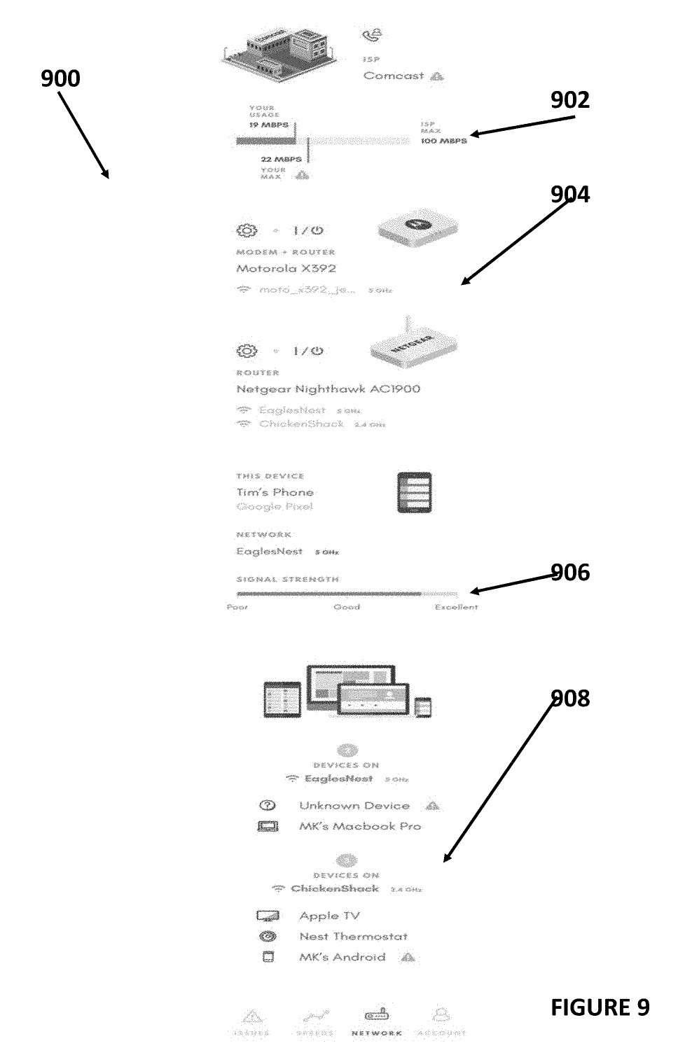

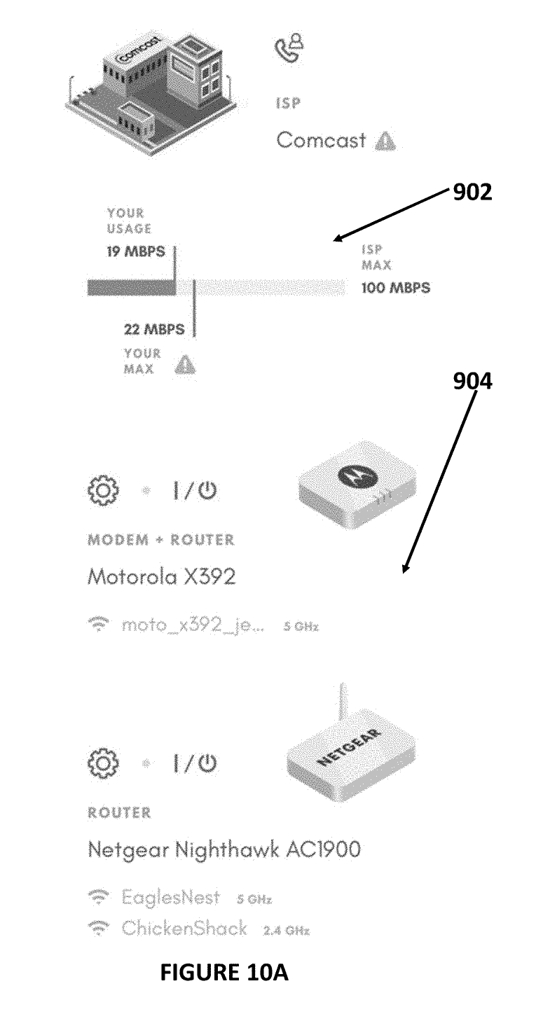

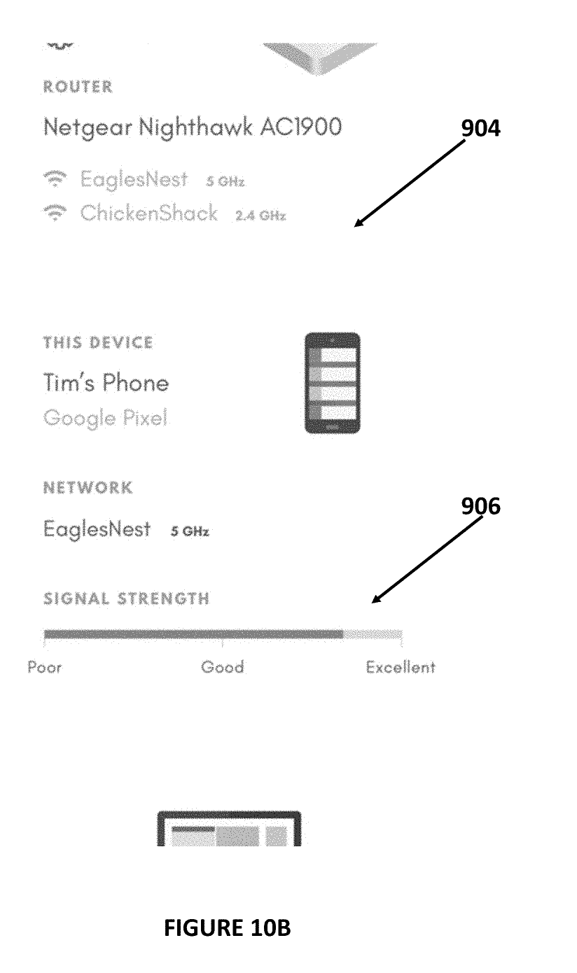

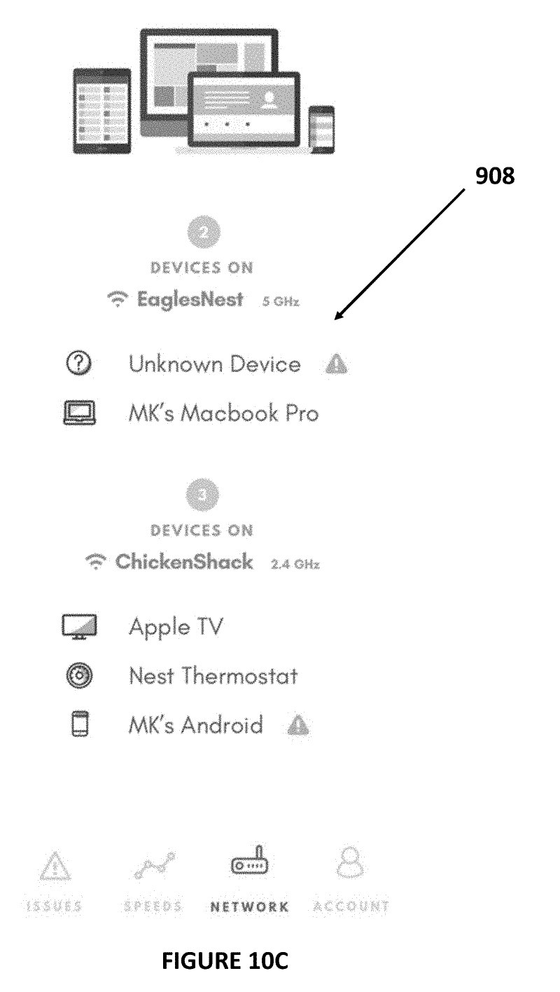

The user interface 600 also may include a download speed comparison portion 608 that allows the user to see their speed relative to other user of the same provider (Comcast in the example in FIG. 6) as well as to other providers of internet service. The user interface 600 also may include a map view portion 610 so that the user can display a map view. The user interface 600 also may include a control portion 612 that allows the user to navigate between different views of the user interface, such as an issues view (an example of which is shown in more detail in FIG. 8), a speeds view (an example of which is shown in FIG. 6), a network view (an example of which is shown in FIGS. 9-10C) and an account view.

FIG. 8 illustrates an example of an issues user interface 800 that may be generated for a particular user by the system based on the data collected from the devices that are part of the user's network. The issues user interface may include a self-reported portion 802 that displays issues that have been reported by the particular user and an auto-detected portion 804 that may be generated by the system and displayed to the user. The user interface also may include a reporting portion 806 so that the user can report an issue (which is then displayed in the self-reported portion) and a control portion 808 as described above.

FIG. 9 illustrates a network status user interface 900 for a particular user of the system. The user interface may have a usage portion 902 that displays the user's current usage, a maximum usage for the user a maximum bandwidth for the ISP of the user. The user interface also may include a network portion 904 that displays characteristics of the devices (a modem and router and iPhone in the example in FIG. 9) that form the network. The portions 902 and 904 are shown in greater detail in FIG. 10A.

The user interface 900 also may include a signal strength portion 906 that displays a signal strength of the network at the current time that the user interface is displayed. The portion 906 is shown in greater detail in FIG. 10B. The user interface 900 also may include a devices portion 908 that shows various details of the devices that are utilizing the network for internet connectivity. The portion 908 is shown in greater detail in FIG. 10C.

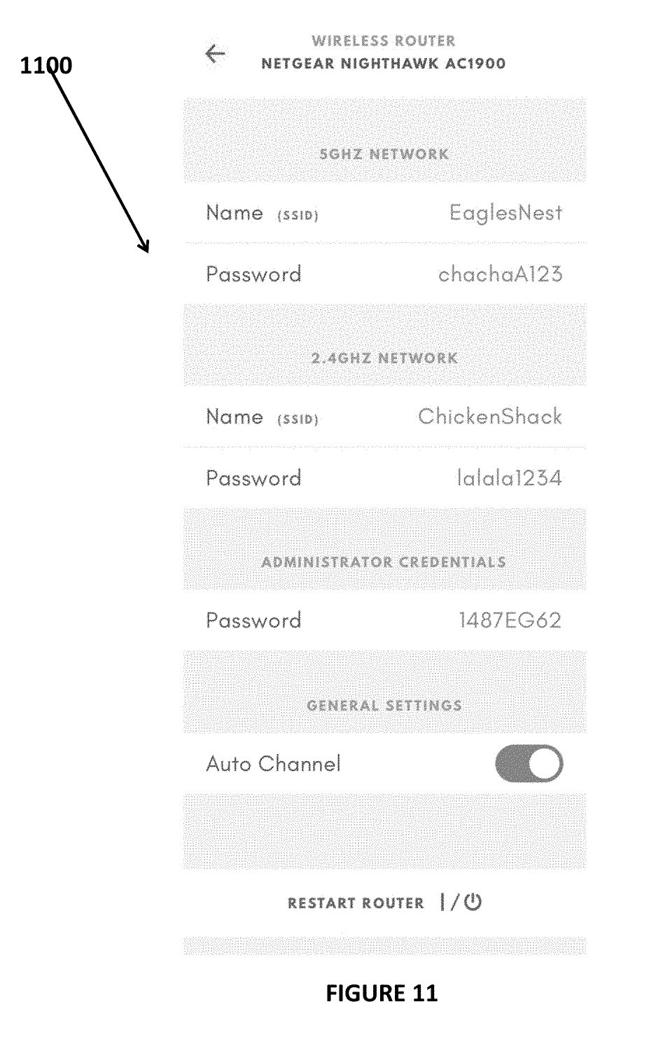

FIG. 11 illustrates a user interface 1110 for a particular device that is part of the network that shows further details about that device. The user interface may display the various passwords for the device as well as the menu item to restart the device (which is a router in the example in FIG. 11).

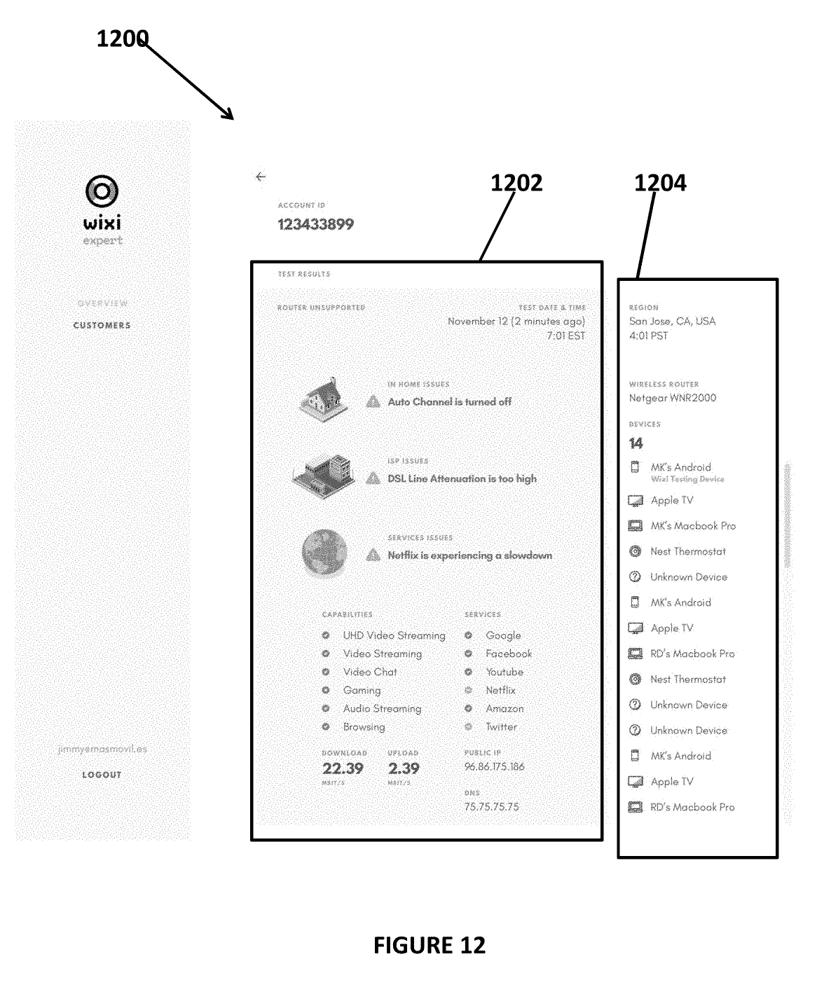

FIG. 12 illustrates an example of an internet service provider user interface 1200 that may be generated by the system. In the example in FIG. 12, the user interface shows the ISP the details for a particular customer of the ISP. The user interface may include a test results portion 1202 that displays the various tests results for the particular customer so that, for example, the ISP can determine if a truck needs to be sent to the customer to fix the problem as described above. The user interface also may have a device portion 1204 that displays the devices of the particular customer accessing the network for internet connectivity.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method, comprising:
receiving data from one or more devices in a network, each of the devices being supplied by a particular partner and being part of the network in a premises, wherein the one or more devices affect one of internet and WiFi performance of the network;
generating test data about a performance of the one or more devices in the network that affect one of internet and WiFi performance of the network;
diagnosing, based on the data from the one or more devices and the test data, a condition of at least one of the one or more devices; and
generating, using machine learning, one or more pieces of actionable advice, for at least one of the one or more devices, to the partner that supplied the at least one device for the network based on the diagnosed condition of the at least one device, the one or more pieces of actionable advice improving one of internet and WiFi performance of the network.

2. The method of claim 1, wherein receiving data from one or more devices in a network further comprises normalizing the data from the one or more devices.

3. The method of claim 1 further comprising storing the data from the one or more devices in a cloud.

4. The method of claim 1, wherein diagnosing the condition further comprises identifying a condition affecting one of internet and WiFI performance and diagnosing one or more causes underlying the identified condition.

5. The method of claim 1, wherein receiving data from one or more devices in a network further comprises receiving data from a wireless router.

6. The method of claim 1 further comprising taking one or more actions corresponding to the one or more actionable pieces of advice to modify the one or more identified conditions to improve one of the internet and WiFi performance of the network.

7. A method, comprising:
receiving data from one or more devices in a network, each of the devices being part of the network in a premises, wherein the one or more devices affect one of internet and WiFi performance of the network;
generating test data about a performance of the one or more devices in the network that affect one of internet and WiFi performance of the network;
diagnosing, using the data from the one or more devices and the test data, a condition of at least one of the one or more devices; and
generating, using machine learning, one or more pieces of actionable advice, for at least one of the one or more devices, to the consumer based on the diagnosed condition of the at least one device, the one or more pieces of actionable advice improving one of internet and WiFi performance of the network.

8. The method of claim 7, wherein receiving data from one or more devices in a network further comprises normalizing the data from the one or more devices.

9. The method of claim 7 further comprising storing the data from the one or more devices in a cloud.

10. The method of claim 7, wherein diagnosing the condition further comprises identifying a condition affecting one of internet and WiFI performance and diagnosing one or more causes underlying the identified condition.

11. The method of claim 7, wherein receiving data from one or more devices in a network further comprises receiving data from a wireless router.

12. The method of claim 7 further comprising taking one or more actions corresponding to the one or more actionable pieces of advice to modify the one or more identified conditions to improve one of the internet and WiFi performance of the network.

13. A system, comprising:
a computer system having a processor and a memory;
the computer system having a testing server and a machine learning based advice engine;
the testing server receives data from one or more devices in a network, each of the devices being supplied by a particular partner and being part of the network in a premises, wherein the one or more devices affect one of internet and WiFi performance of the network and generates test data about a performance of the one or more devices in the network that affect one of internet and WiFi performance of the network; and
the machine learning based advice engine receives the data from one or more devices in the network and the test data, performs machine learning analysis on the data from the one or more devices and the test data to diagnose a condition of at least one of the one or more devices and generates one or more pieces of actionable advice, for at least one of the one or more devices, to the partner that supplied the at least one device for the network based on the diagnosed condition of the at least one device, the one or more pieces of actionable advice improving one of internet and WiFi performance of the network.

14. The system of claim 13, wherein the computer system further comprises a data normalizer that normalize the data from the one or more devices.

15. The system of claim 13, wherein the computer system further comprises a data store that stores the data from the one or more devices in a cloud.

16. The system of claim 13, wherein the machine learning based advice engine identifies a condition affecting one of internet and WiFI performance and diagnoses one or more causes underlying the identified condition.

17. A system, comprising:
a computer system having a processor and a memory;
the computer system having a testing server and a machine learning based advice engine;
the testing server receives data from one or more devices in a network, each of the devices being part of the network in a premises and affecting one of internet and WiFi performance of the network and generates test data about a performance of the one or more devices in the network that affect one of internet and WiFi performance of the network; and
the machine learning based advice engine receives the data from one or more devices in the network and the test data, performs machine learning analysis on the data from the one or more devices and the test data to diagnose a condition of at least one of the one or more devices and generates one or more pieces of actionable advice, for at least one of the one or more devices, to the consumer based on the diagnosed condition of the at least one device, the one or more pieces of actionable advice improving one of internet and WiFi performance of the network.

18. The system of claim 17, wherein the computer system further comprises a data normalizer that normalize the data from the one or more devices.

19. The system of claim 17, wherein the computer system further comprises a data store that stores the data from the one or more devices in a cloud.

20. The system of claim 17, wherein the machine learning based advice engine identifies a condition affecting one of internet and WiFI performance and diagnoses one or more causes underlying the identified condition.
